(19) United States
(12) Patent Application Publication
(10) Pub. No.: US 2004/0231379 A1
(43) Pub. Date: Nov. 25, 2004

(54) Shaft-type locking cylinder and dedicated key

(76) Inventor: Chin-Shen Yu, Shing-Juang City (TW)

Correspondence Address: Mr. Pan, Meng-Tsuey, P.O. Box 1-252, Sanchung City, TW

(21) Appl. No.: 10/462,252

(22) Filed: Jun. 13, 2003

(30) Foreign Application Priority Data
May 20, 2003 (TW) 092209215

(51) Int. Cl. E05B 25/00; E05B 27/08

(52) U.S. Cl. 70/491; 70/386

(57) ABSTRACT

A shaft-type locking cylinder and dedicated key comprises a locking cylinder base, a main mount, a key, a plurality of tumbler pins, a plurality of springs, and a plurality of steel balls. The plurality of tumbler pins, springs and steel balls situated in the locking cylinder base are placed into a bore in the main mount, thereby enabling the fitting of an annular shoulder at the front end of the locking cylinder base into a first stepped rim in the main mount, the seating of a retaining ring in a second stepped rim to secure the locking cylinder base in the main mount and, furthermore, the concealment of the tumbler pins installed within the locking cylinder base. The said key further comprises a toggling barrel member having a plurality of differing-depth arcuate notches, a vertical slot in the toggling barrel member and a horizontal slot formed at one side of the vertical slot.

### BACKGROUND OF THE INVENTION

1) Field of the Invention

The invention herein relates to lock mechanisms, specifically an improved shaft-type locking cylinder and dedicated key that provides a type of lock system that is impervious to unlocking tools, lock picks, and prying actions, thereby preventing theft due to lock damage, while remaining conveniently installable.

2) Description of the Prior Art

The invention herein is in reference to Taiwan Patent Bulletin Patent No. 519,989 and No. 486,001, two new patent applications that both claimed further improvement to the related art.

The applicant of the invention herein previously submitted application No. 91,208,413 “Improved Tubular-type Locking Cylinder and Dedicated Key” to the Taiwan Bureau of Patents on Jun. 6, 1991, the granted patent rights of which have already expired (publicly disclosed on Feb. 1, 1992 under Taiwan Patent Bulletin Patent No. 519,989) but which is briefly elaborated for informational purposes.

Since the improvement to the said patent consists of forming a detent slot on the locking cylinder shaft recess of the main base body and, furthermore, improved by means of a bore through the center of the shaft member of the locking cylinder shaft and a movably disposed catch bolt and a spring; a horizontal passage for seating the steel ball fabricated in the shaft member at the lower side of a tumbler pin disc, and the said catch bolt consists of a bolt member having an annular groove and, furthermore, a pin situated near the upper extremity at one side of the bolt member, therefore, the said tubular-type locking cylinder is equipped with the original quantity of tumbler pin assemblies to achieve the locking and theft-resistant capabilities expected of a locking cylinder. Furthermore, since the arrangement also integrates the catch bolt, the springs, and the steel balls as well as the detent slot in the main base, the said invention achieves the objective of preventing theft by means of skeleton keys, lock picks, and other unlocking tools utilized to unlawfully defeat locks through probing and prying. As such, the said improved tubular-type locking cylinder and dedicated key was popular and acclaimed by consumers ever since it was introduced onto the commercial market. At present, a patent application is submitted that further enhances performance through the utilization of a shaft-type locking cylinder, but while still under review, Taiwan Patent Bulletin Patent No. 486,001 (disclosed in May 1991 and shown in FIG. 9; referred to hereafter as the cited case) was observed as a prior art patent in the same category as the invention herein. However, upon detailed comparison, the cited case still has the following shortcomings:

1. The structural design of the cited case is a shaft-type locking cylinder in which the locking cylinder base 1 is coupled to a plurality of tumbler pins 12, a spring 11 and an elongate tumbler pin 120, a spring 11 and a plurality of steel balls 14, and a long pin 16 that are all movably disposed into a main base 2 via a bore at the rear end of the said main base 2, with a C-shaped ring (not shown in the cited case, but disclosed as a C-shaped ring clipped onto an annular groove 23) maintaining their internal installation. Since the said main base 2 ensleeves the said locking cylinder base 1 within its inner walls, a plurality of vertical grooves 20 are therein disposed and, as such, the load withstanding strength at the outer sides of the said grooves 20 is rather limited to the extent that a thief would only have to insert a screwdriver or other similar tool into the circular channel 21 at the front end of the said main base 2 and then hammer it to destroy the locking cylinder of the cited case, illustrating the lack of any effective theft-resistant capability because the objective of theft-motivated lock breaking is so simply accomplished.

2. In the locking cylinder of the cited case, the annular grooves 122 formed on the tumbler pins 12 and the elongate tumbler pin 120 consist of arcuately profiled annular grooves that contact a steel ball 14 or end surface of the long pin 16 and, as such, the movement of the said steel balls and long pin 16 becomes difficult after steel ball 14 or long pin 16 engagement and, furthermore, easily results in the immobilization of the steel balls 14 and/or the jamming of the long pin 16, a condition that does not facilitate locking operation.

3. The locking cylinder of the cited case only has one slot 22 on one side of the circular channel 21 at the front end of the main base 2 to facilitate key positioning and entry for locking and unlocking; however, no mounting structure or arrangement that sets the unlocking angle is provided and a positioning structure or additional locating element must be disposed at the rear end of the said main base 2 and its locking cylinder base 1 before actual installation and utilization is possible; as such, the locking cylinder of the cited evidence has not reached the practical application stage.

4. With the locking cylinder of the cited case, each of the springs 11 movably disposed inside the locking cylinder base 1 directly contacts a tumbler pin 12 and an elongate tumbler pin 120; therefore, when picked (probed) by a thief to force unlocking, they are easily depressed all the way down, readily deform, or lose resilience (fatigue), often resulting in the malfunctioning of the said locking cylinder to the extent that its dedicated key is no longer capable of the unlocking operation.

In view of the said shortcomings apparent in the conventional (the cited case) shaft-type locking cylinder, the applicant of the invention herein developed the improved shaft-type locking cylinder and dedicated key of the invention herein based on the further refinement of the technological ideas disclosed under Taiwan Patent Bulletin Patent No. 519,989.

### SUMMARY OF THE INVENTION

The objective of the invention herein is to provide an improved shaft-type locking cylinder and dedicated key in which a locking cylinder base and its plurality of tumbler pins, springs, and steel balls are movably disposed into a main mount via the front end of a mount member of the said main mount and then secured in position by a retaining ring seated in the front end; the said locking cylinder base is thereby firmly ensconced inside the said main mount and not easily hammered, destroyed, and unlocked by thieves.

Another objective of the invention herein is to provide an improved shaft-type locking cylinder and dedicated key in which the retaining ring is substantially thick and has an opening that accommodates the entry of a toggling barrel member on a key and, furthermore, conceals the plurality of tumbler pins and springs installed within the locking cylinder base, while also increasing the degree of invasive tampering difficulty and thereby complicating theft by lock picking and probing.

Yet another objective of the invention herein is to provide an improved shaft-type locking cylinder and dedicated key in which each tumbler pin has a columnar recess formed in its posterior extremity, enabling the entry of a spring and providing sufficient space for the compression of the said spring to avert total compression that results in deforming and loss of resilience (fatigue); at the same time, each said tumbler pin has annular grooves that are V-shaped to lessen the likelihood of pin and other component immobilization and jamming.

Still another objective of the invention herein is to provide an improved shaft-type locking cylinder and dedicated key in which the toggling barrel member of the key has a vertical slot as well as a horizontal slot; a first and a second locating pin are respectively installed in the locking cylinder base and the retaining ring of the shaft-type locking cylinder to serve as a mounting structure that sets the unlocking angle such that no additional positioning or locating structures are required which further enhances the theft-resistant capabilities of the present invention.

### BRIEF DESCRIPTION OF THE DRAWINGS

FIG. 1 is a cross-sectional drawing of the improved shaft-type locking cylinder of the invention herein in the locked state.

FIG. 2 is a cross-sectional drawing of the improved shaft-type locking cylinder of the invention herein at instant of unlocking.

FIG. 3 is an exploded drawing of the invention herein.

FIG. 4 is a cross-sectional drawing of the improved shaft-type locking cylinder of the invention herein at the instant of unlocking, as viewed from another angle.

FIG. 5 is a cross-sectional drawing of FIG. 1, as viewed from the perspective of line 5-5′.

FIG. 6 is a cross-sectional drawing of FIG. 2, as viewed from the perspective of line 6-6′.

FIG. 7 is a cross-sectional drawing of FIG. 1, as viewed from the perspective of line 7-7′.

FIG. 8 is a cross-sectional drawing of the improved shaft-type locking cylinder of the invention herein during the locked state, the same state as that of FIG. 1 viewed from the perspective of 7-7′.

FIG. 9 is a cross-sectional drawing of the shaft-type locking cylinder disclosed under Patent No. 486,001 in the Taiwan Patent Bulletin.

### DETAILED DESCRIPTION OF THE INVENTION

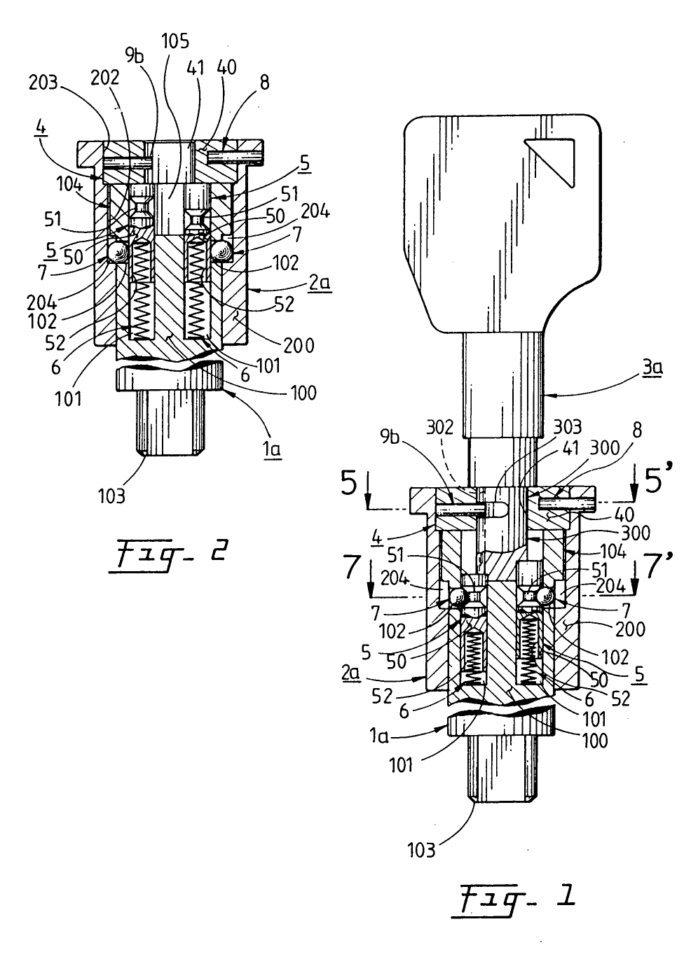

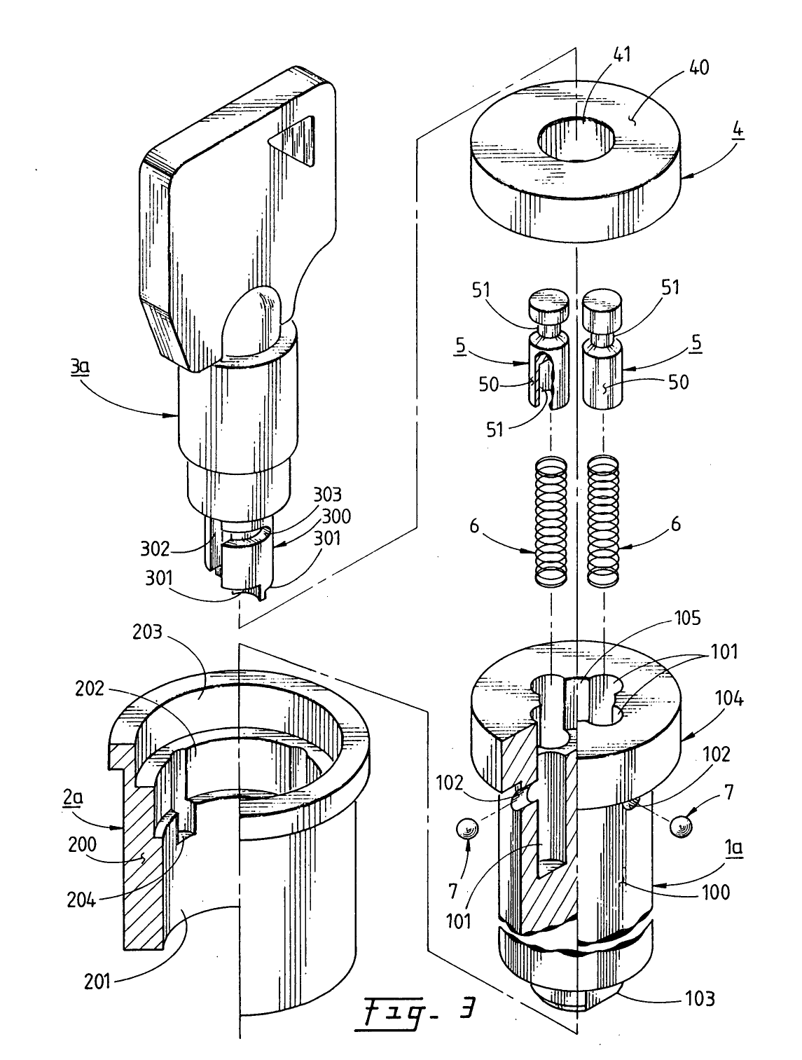

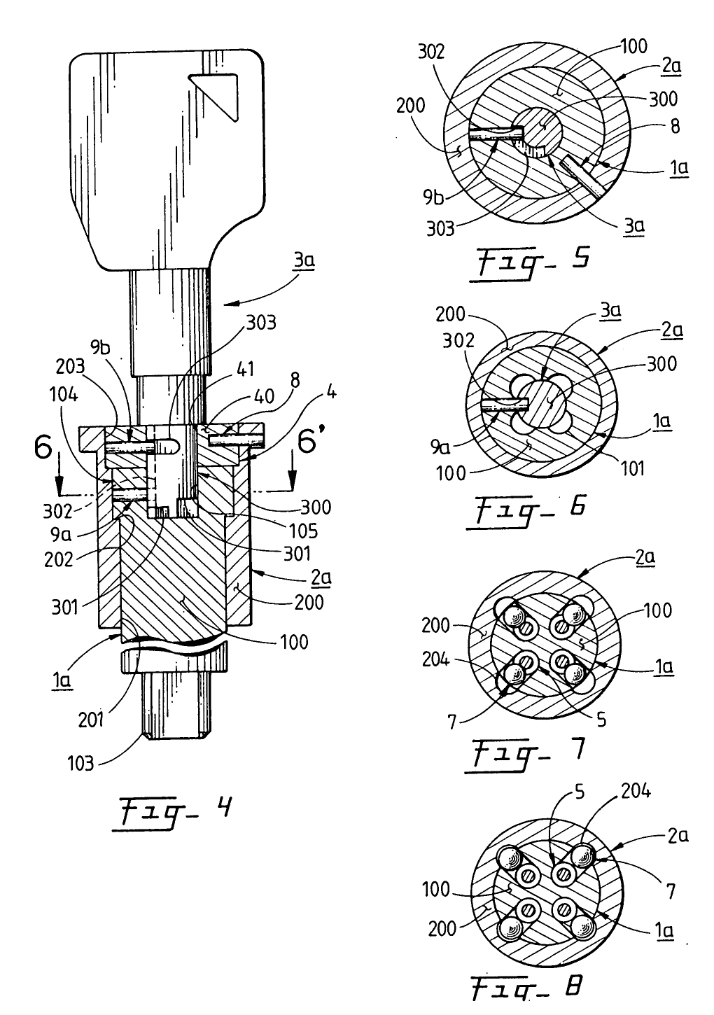

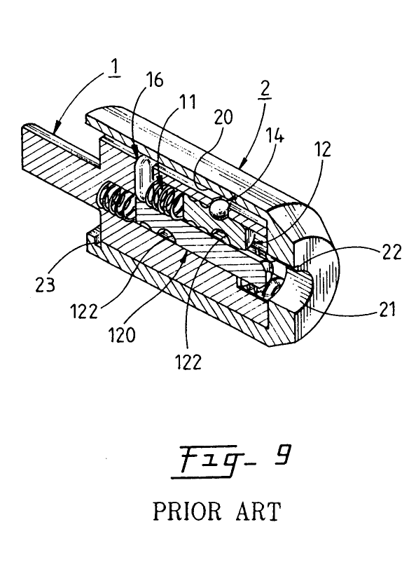

Referring to FIG. 1, FIG. 2, and FIG. 3, the shaft-type locking cylinder of the invention herein, as with the cited case, is comprised of a locking cylinder base 1a, a main mount 2a, a key 3a, a plurality of tumbler pins 5, a plurality of springs 6, and a plurality of steel balls 7; however, the components and installation approach are improved as follows:

The said locking cylinder base 1a, in addition to its similarities with the conventional shaft-type locking cylinder, consists of a base member 100 having a plurality of close-ended, vertical columnar recesses 101 in the front portion for movably positioning the tumbler pins 5 and the springs 6; a plurality of horizontal passages 102 in the surface of the said base member 100 that are contiguous with the said vertical columnar recesses 101 for emplacing a steel ball 7; and in addition to a flat 0-shaped rod or threaded rod 103 that is connected to a lock, a driven component, or an implement, the invention herein is improved by disposing an annular shoulder 104 at the front end of the said base member 100 that enables a press fit into the said main mount 2a and, furthermore, a channel 105 is formed through the center of the said base member 100 from its front end that provides for the entry of the key 3a that accomplishes the unlocking operation.

The said main mount 2a completely differs from that of the said cited case and consists of a mount member 200, a bore 201 at the front end for installing the locking cylinder base 1a, and a first and a second stepped rim 202 and 203 for the respective seating of the locking cylinder base 1a and a retaining ring 4 (as shown in FIG. 1, FIG. 2, and FIG. 3); the plurality of horizontal passages 102 in the said locking cylinder base 1a base member 100 are aligned with a plurality of vertical slots 204 in the inner wall of the said bore 201 that do not penetrate the base member 100 and which provide for the entry of a steel ball 7 (as shown in FIG. 8).

Each said tumbler pin 5, as with that of the cited case, consists of a cylindrical member 50 having an annular groove 51 formed around the front portion at varying distances from the end surface of its anterior extremity, with the said annular grooves 51 not arcuately profiled, but V-shaped; at the same time, a columnar recess 52 is formed in the posterior extremity of the cylindrical member 50, enabling the entry of a spring 6 and providing sufficient space for the compression of the said spring 6.

The said key 3a, as with that of the said cited case, has a plurality of differing depth arcuate notches 301 in its toggling barrel member 300 that matches the position and inward travel distance of the said plurality of tumbler pins 5, but the key 3a of the invention herein is improved by the inclusion of a vertical slot 302 in the surface of the said toggling barrel member 300 and, furthermore, a horizontal slot 303 formed at one side of the said vertical slot 302 that drives the unlocking of the said locking cylinder base 1a and limits its angular range; at the same time, since the distance between the said horizontal slot 303 and the leading end of the said toggling barrel member 300 is changeable, a greater range of variations in the key 3a is possible.

As for the retaining ring 4 shown in FIG. 1, FIG. 2, and FIG. 3, it consists of an annular member 40 having an opening 41, the inner diameter of which matches the outer diameter of the said key 3a toggling barrel member 300, that is fixed by a pin 8 in the second stepped rim 203 of the main mount 2a mount member 200 and utilized to secure the locking cylinder base 1a in the said main mount 2a such that it cannot be moved forward and dismounted.

When the improved shaft-type locking cylinder of the invention is assembled, the plurality of springs 6 and tumbler pins 5 are first respectively placed into the vertical columnar recesses 101 in the locking cylinder base 1a base member 100; the plurality of steel balls 7 are respectively placed into the horizontal passages 102 in the said base member 100; a first locating pin 9a is inserted into the annular shoulder 104 of the said base member 100 such that it goes through the channel 105 (as shown in FIG. 4) and the bore 201 of the main mount 2a mount member 200, causing the respective entry of the said plurality of steel balls 7 into the said plurality of vertical slots 204 in the inner wall of the said bore 201; a second locating pin 9b is thereafter inserted into the annular member 40 of the retaining ring 4 and through the second stepped rim 203 of the mount member 200; and the pin 8 conjoins the said annular member 40 and mount member 200 of the main mount 2a into a unitary structural entity, thereby completing assembly (as shown in FIG. 2).

With the improved shaft-type locking cylinder of the invention herein now fully assembled, as indicated in FIG. 2, since the plurality of steel balls 7 are respectively situated in the horizontal passages 102 in the locking cylinder base 1a base member 100 as well as the vertical slots 204 in the main mount 2a mount member 200, this constitutes the locked state; since a second locating pin 9b and a first locating pin 9a are respectively inserted into the retaining ring 4 of the invention herein and the said locking cylinder base 1a, the vertical slot 302 and the horizontal slot 303 must be formed in the toggling barrel member 300 of the key 3a to enable unlocking operation capability; it is only necessary to align the vertical slot 302 in the toggling barrel member 300 of the key 3a of the invention herein with the position of the second locating pin 9b on the retaining ring 4, insert the key 3a through the opening 41 in the center of the retaining ring 4 annular member 40 to gain admittance into the vertical columnar recesses 101 centered in the front portion of the said locking cylinder base 1a base member 100 and thereby contact the tumbler pins 5 inside, the key 3a is then rotated such that the vertical slot 302 in the said toggling barrel member 300 causes the said first locating pin 9a to revolve the said locking cylinder base 1a to efficiently complete the unlocking operation; if the vertical slot 302 is not present on the toggling barrel member 300 of the key 3a when it is inserted through the opening 41 in the center of the retaining ring 4 annular member 40 to unlock the improved shaft-type locking cylinder of the invention herein, the said second locating pin 9b obstructs penetration up to the plurality of tumbler pins, 5 such that unlocking is not possible; if the said vertical slot 302 is present but the horizontal slot 303 is absent on the key 3a when it is inserted through the opening 41 in the center of the retaining ring 4 annular member 40 to unlock the improved shaft-type locking cylinder of the invention herein, although admittance is gained into the vertical columnar recesses 101 in the said locking cylinder base 1a base member 100 to thereby contact the plurality of tumbler pins 5, the rotation of the said retaining ring 4 annular member 40 is blocked by the second locating pin 9b such that unlocking is not possible. As such, the improved shaft-type locking cylinder of the invention herein is effectively theft-proof.

1. A shaft-type locking cylinder and dedicated key comprising:
a locking cylinder base;
a main mount seating a base member of said locking cylinder base and having a bore for installing said locking cylinder base;
a plurality of tumbler pins;
a key comprising a toggling barrel member having a plurality of differing-depth arcuate notches at a leading edge of said toggling barrel member that matches the position and inward travel distance of said tumbler pins and thereby serves as the interfacing means of unlocking the present invention;
a plurality of springs; and
a plurality of steel balls.

2. (Cancelled)

3. As mentioned in claim 1 of the shaft-type locking cylinder and dedicated key, said locking cylinder base is also comprised of:
an annular shoulder at a front of said base member that enables a press fit into said main mount;
a channel formed through the center of said base member from its front end that provides for the entry of said key to accomplish unlocking operation;
a first locating pin installed into said annular shoulder that penetrates through said channel; and
a second locating pin installed into an annular member of a retaining ring that penetrates an opening of said annular member.

4. As mentioned in claim 1, wherein each of said tumbler pins consists of a cylindrical member having a flat V-shaped annular groove formed around a front surface at varying distance from anterior end of said cylindrical member.

5. As mentioned in claim 1, wherein said key further comprises a vertical slot in a surface of said toggling barrel member and a horizontal slot formed at one side of said vertical slot.

6. As mentioned in claim 3, wherein said locking cylinder base also includes:
a plurality of vertical columnar recesses in its front portion for movably positioning said tumbler pins and said springs;
a plurality of horizontal passages in its surface that are contiguous with said vertical columnar recesses for emplacing said steel balls; and
a flat O-shaped rod or threaded rod connected to a lock, a driven component or an implement.

7. As mentioned in claim 1, wherein said main mount further consists of a first and a second stepped rim at front end of said bore, and furthermore, a plurality of vertical slots in the inner wall of said bore aligned with the plurality of horizontal passages in said locking cylinder base which provide for the insertion of said steel balls.
